(19) United States
(12) Patent Application Publication
(10) Pub. No.: US 2006/0091620 A1
(43) Pub. Date: May 4, 2006

(54) Chuck device

(75) Inventors: Kazuo Sakamaki, Ojiya-shi (JP); Akira Sakamaki, Ojiya-shi (JP); Tadashi Taniguchi, Ojiya-shi (JP)

Correspondence Address: SUGHRUE MION, PLLC, 2100 PENNSYLVANIA AVENUE, N.W., SUITE 800, WASHINGTON, DC, 20037, US

(73) Assignee: YUKIWA A SEIKO KABUSHIKI KAISHA

(21) Appl. No.: 11/077,134

(22) Filed: Mar. 11, 2005

(30) Foreign Application Priority Data
Oct. 29, 2004 (JP) 2004-315597 (PAT.
Dec. 9, 2004 (JP) 2004-356972 (PAT.

(51) Int. Cl. B23B 31/12

(52) U.S. Cl. 279/62

(57) ABSTRACT

To provide a chuck device which is much superior in workability which may readily rotate a rotary sleeve in a loosening direction, a rotary sleeve (2) provided in a body 1 is rotated, jaws (4) threadedly engaged with a rotary nut (3) are opened and closed and moved forward and backward by a rotation of the rotary nut (3) rotating together with the rotary sleeve (2), a tool (5) is clamped or released by the jaws (4), and a rotation grip portion (7) is provided on an outer circumferential surface of the rotary sleeve (2) for gripping and rotating the rotary sleeve (2) by a rotary tool (6) such as a wrench.

### FIELD OF THE INVENTION

The present invention relates to a chuck device for clamping a tool such as a drill or an end mill.

### BACKGROUND OF THE INVENTION

As a chuck device, a device is provided in which a rotary sleeve provided in a body is rotated, jaws engaging with a rotary nut is opened and closed by the rotation of the rotary nut rotating together with this rotary sleeve and the tool is closed and opened by the jaws.

Such a conventional chuck device is adapted so that the rotary sleeve is gripped and rotated to thereby close and open and move the jaws forward and backward.

### PROBLEMS TO BE SOLEVED BY THE INVENTION

However, in the case where the tool is used while rotating at a high speed, there is a fear that the rotary sleeve would be too tightened or loosened due to its rotational direction. In particular, in the case where the rotary sleeve is too tightened, there is a fear that the rotary sleeve would hardly be loosened.

### SUMMARY OF THE INVENTION

Accordingly, in order to overcome the above-noted defects, an object of the present invention is to provide a chuck device which is much superior in workability in which a rotary sleeve may readily be rotated in a loosening direction.

The essence of the present invention will now be described with reference to the accompanying drawings.

The invention relates to a chuck device in which a rotary sleeve 2 provided in a body 1 is rotated, jaws 4 threadedly engaged with a rotary nut 3 are opened and closed and moved forward and backward by a rotation of the rotary nut 3 rotating together with the rotary sleeve 2, and a tool 5 is clamped or released by the jaws 4, characterized in that a rotation grip portion 7 is provided on an outer circumferential surface of the rotary sleeve 2 for gripping and rotating the rotary sleeve 2 by a rotary tool 6 such as a wrench.

Also, in the chuck device according to the first aspect of the invention, the invention further relates to a chuck device in which the rotation grip portion 7 is provided at a tip end portion of the rotary sleeve 2.

Also, in the chuck device according to the first or second aspect of the invention, the invention further relates to a chuck device the rotation grip portion 7 of the rotary sleeve 2 has a polygonal shape as viewed in cross-sectional view.

With such an arrangement, it is possible to provide a chuck device which is much superior in practical aspect in which it is possible to readily rotate the rotary sleeve with rotary tool; and in the case where the rotary sleeve is too tightened, it is possible to readily loosen the rotary sleeve.

### BRIEF DESCRIPTION OF THE INVENTION

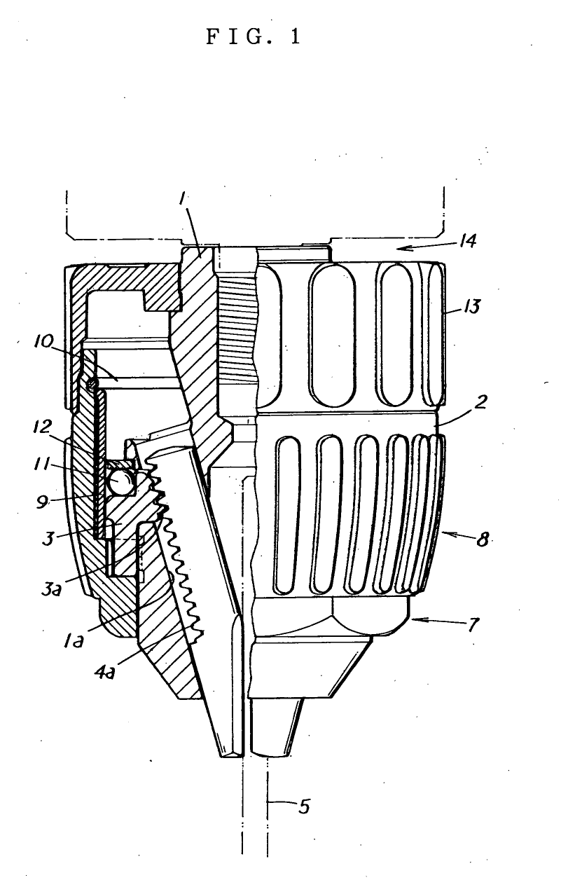

FIG. 1 is an illustrative cross-sectional view of a chuck device according to the present invention.

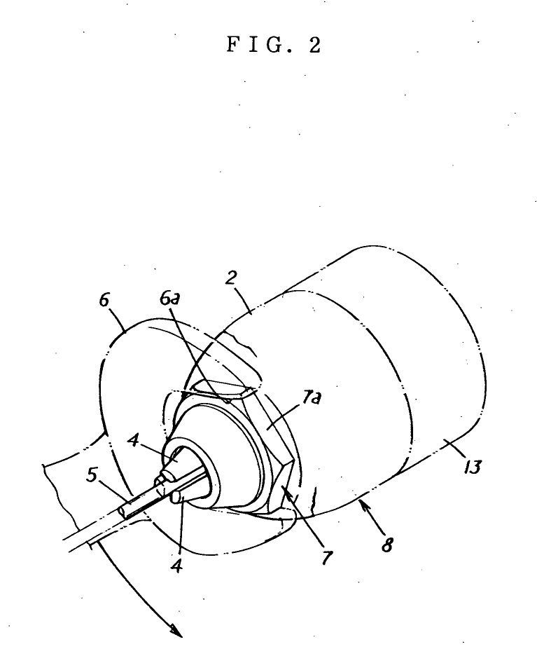

FIG. 2 is a schematic, illustrative perspective view of the chuck device shown in FIG. 1.

### DESCRIPTION OF THE PREFERRED EMBODIMENTS

A best mode for embodying the invention will now be described together with an operational effect with reference to the accompanying drawings.

Since the rotation grip portion 7 of the rotary sleeve 2 may readily be rotated while clamping the rotation grip 7 by the rotary tool 6. for example, even if the work is performed while the tool 5 clamped by the jaws 4 is being rotated at a high speed and the rotary sleeve 2 (a screw portion between the rotary nut 3 and the jaws 4) is excessively tightened, it is possible to readily loosen the rotary sleeve 2.

### Embodiment 1

A specific embodiment of the invention will now be described with reference to the accompanying drawings.

The embodiment of the invention relates to a chuck device in which a rotary sleeve 2 provided in a body 1 is rotated, jaws 4 threadedly engaged with a rotary nut 3 are opened and closed and moved forward and backward by a rotation of the rotary nut 3 rotating together with the rotary sleeve 2, a tool 5 is clamped or released by the jaws 4, characterized in that a rotation grip portion 7 is provided on an outer circumferential surface of the rotary sleeve 2 for gripping and rotating the rotary sleeve 2 by a rotary tool 6 such as a wrench, for example, a monkey wrench and a spanner on the market and standardized by JIS (Japanese Industrial Standard).

The three jaws 4 each passing through slant holes 1a formed in the body 1, projecting to a tip end, slanted relative to an axis of the body 1 and having a tool clamping portion in its inner surface are provided in the body 1. A male screw portion 4a is formed on an outer side of each of the three jaws 4. The rotary nut 3 having a male screw portion 3a is fitted to the jaws 4 and threadedly engaged with the male screw portion 4a.

A two-halved semicircular nut is used as the rotary nut 3.

Also, the rotary sleeve 2 made of synthetic resin is fitted to the body 1. A grip portion 8 is provided on a circumferential surface of the rotary sleeve 2.

A rotation grip portion 7 to be brought into contact with a rotation tip end portion 6a of the rotary tool 6 such as a spanner is provided at the tip end portion of the rotary sleeve 2. Accordingly, not only may the rotary sleeve 2 readily be rotated by manually gripping the grip portion 8 but also the rotary tool 6 such as a spanner may be used for positive rotation of the rotary sleeve 2.

More specifically, the rotation grip portion 7 has a hexagonal shape in cross-section. Accordingly, it is possible to readily retain the rotation tip end portion 6a of the rotary tool 6 such as a wrench. It is therefore possible to rotate the rotary sleeve 2. Incidentally, in this embodiment, although the rotation grip portion 7 has the hexagonal shape in cross section, it is possible to set up the shape to any other polygonal shape such as octagonal shape in cross section.

Also, a contact surface 7a with the rotation tip end portion 6a of the rotary tool 6 is set up to substantially the same width as that of the rotation tip end portion 6a. Accordingly, the contact surface 7a is wide enough and needed to grip the rotary sleeve 2 by the rotation tip end portion 6a of the rotary tool 6. It is possible to perform the rotation of the rotary sleeve 2 and unnecessary to reduce the region of the grip portion 8 more than necessary.

Also, the rotation grip portion 7 is provided at a tip end portion of the rotary sleeve 2 having a smaller diameter than that of a sleeve portion of the rotary sleeve 2. Accordingly, a spanner having a smaller diameter may be fit to the rotation grip portion 7.

Convex and concave fitting portions (drive key) are provided between the tip end of the rotary nut 3 and an inner stepped surface of the rotary sleeve 2 is provided for rotating together the rotary nut 3 and the rotary sleeve 2. The convex and concave fitting portions are provided in the form of one pair in confronting condition.

Incidentally, reference numeral 9 denotes an annular member for retaining a shape of the divided nut in an annular shape, numeral 10 denotes, a stop ring for preventing the annular member from being pulled out, numeral 11 denotes rolling members (steel balls, ceramic balls, plastic balls) provided between the nut member 3 and a receiving portion 12 of the body 12, numeral 13 denotes a grip sleeve provided in a rotation preventing manner in the body 1 and numeral 14 denotes a joint portion for coupling with a main shaft of an electric drill.

In operation of this embodiment, the tool 5 is inserted between the three jaws 4 and the rotary sleeve 2 (rotary nut 3) is manually rotated so that the jaws 4 are closed and advanced to grip the tool 5 to thereby perform, for example, boring by the tool 5. In this case, in the case where the rotary sleeve 2 is excessively tightened, the rotation grip portion 7 is gripped and rotated by the rotary tool 6 so that the rotary sleeve 2 is rotated in the loosening direction.

With such an arrangement of this embodiment, it is possible to readily rotate the rotation grip portion 7 of the rotary sleeve 2 by gripping the rotary tool 6. Accordingly, for example, even if the tool 5 gripped by the jaws 4 is used to work while being rotated at a high speed and the rotary sleeve 2 (the screw portions between the rotary nut 3 and the jaws 4) is excessively tightened, it is possible to readily loosen the rotary sleeve 2.

Also, the rotation grip portion 7 is set up in a hexagonal shape in cross section. Therefore, it is easy to retain the rotation tip end portion 6a of the rotary tool 6 such as a wrench to thereby make it possible to readily rotate the rotary sleeve 2.

Also, since the rotation grip portion 7 is provided at the tip end portion of the rotary sleeve 2 having a smaller diameter than that of the sleeve portion of the rotary sleeve 2, the rotary sleeve 2 may be rotated by a spanner or the like having a smaller diameter.

As a consequence, according to the present invention, it is possible to provide a chuck device which is much superior in practical use in which it is possible to readily rotate the rotary sleeve by the rotary tool and even if the rotary sleeve is excessively tightened, it is possible to readily loosen the rotary sleeve.

1. A chuck device in which a rotary sleeve provided in a body is rotated, jaws threadedly engaged with a rotary nut are opened and closed and moved forward and backward by a rotation of the rotary nut rotating together with the rotary sleeve, and a tool is clamped or released by the jaws, characterized in that a rotation grip portion is provided on an outer circumferential surface of the rotary sleeve for gripping and rotating the rotary sleeve by a rotary tool such as a wrench.

2. The chuck device according to claim 1, further characterized in that the rotation grip portion is provided at a tip end portion of the rotary sleeve.

3. The chuck device according to claim 1, further characterized in that the rotation grip portion of the rotary sleeve has a polygonal shape as viewed in cross-sectional view.

4. The chuck device according to claim 2, further characterized in that the rotation grip portion of the rotary sleeve has a polygonal shape as viewed in cross-sectional view.
